(19) United States
(12) Patent Application Publication
(10) Pub. No.: US 2010/0095217 A1
(43) Pub. Date: Apr. 15, 2010

(54) Server-based data management system and method for mobile communication system

(75) Inventor: Ji-Hoon Kang, Seoul (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/587,460

(22) Filed: Oct. 7, 2009

(30) Foreign Application Priority Data
Oct. 10, 2008 (KR) 10-2008-0099456

(51) Int. Cl. G06F 3/048; G06F 15/16

(52) U.S. Cl. 715/738; 715/744; 715/847

(57) ABSTRACT

A server-based data management system is capable of maintaining reliable data synchronization between a server and a mobile terminal is provided. The server-based data management system and method includes at least one mobile terminal that displays at least one shortcut icon and a server that stores per-icon position information of the at least one shortcut icon. The server based management system and method transmits a first per-icon position information of the at least one shortcut icon from the mobile terminal to the server. The server compares the first per-icon position information with a second per-icon position information that previously was stored in server. The server transmits the second per-icon position information that is not identical with the first per-icon position information from the server to the mobile terminal. Thereafter, a mobile terminal updates the first per-icon position information to the second per-icon position information.

### CROSS-REFERENCE TO RELATED APPLICATION(S) AND CLAIM OF PRIORITY

The present application is related to and claims priority to an application entitled “SERVER-BASED DATA MANAGEMENT SYSTEM AND METHOD FOR MOBILE COMMUNICATION SYSTEM” filed in the Korean Intellectual Property Office on Oct. 10, 2008 and assigned Serial No. 10-2008-0099456, the contents of which are incorporated herein by reference.

### TECHNICAL FIELD OF THE INVENTION

The present invention relates to a mobile communication, in particular, a server-based data management system and method for a mobile communication system that is capable of maintaining reliable data synchronization between a server and a mobile terminal.

### BACKGROUND OF THE INVENTION

Nowadays, a mobile terminal has become a social networking tool among the people. With the increase of social networking behaviors on the mobile terminals, the mobile communication operators are developing and offering various designated number discount services. The designated number discount service allows a subscriber to designate phone numbers to which calls are made frequently. The mobile communication operator stores the designated phone numbers in the form of a database and discounts the charges for the calls made to the designated phone numbers.

As an example of the designated number discount service, “My faves” allows the subscriber to registers favorite phone numbers with unique icons using a “my faves” application such that the subscriber can make a call to the corresponding phone number with discounted communication rate. Using such a designated number discount service application, the subscriber can place the pictures or icons registered with the designated phone numbers in the idle mode screen of the mobile terminal. Here, the user data including the designated phone numbers represented by the pictures or the icons are transmitted to the communication operator's server so as to be stored in the database.

In order to accomplish the designated number discounter service, the user data stored in the mobile terminal and the database of the communication operator's server must be synchronized when the user data is updated (e.g., a designated phone number represented by an icon is changed or a new phone number is designated with a picture) in the mobile terminal. A conventional data synchronization procedure between the mobile terminal and the server is described with reference to FIG. 1. FIG. 1 illustrates a sequence diagram for operations in a conventional server-based data management system comprising a server and a mobile terminal.

Referring to FIG. 1, if a subscriber requests a data synchronization clicking a menu item or a function key (i.e., using a manual refresh function) after changing the data represented by specific icons displayed on the screen of the mobile terminal 200, the mobile terminal 200 sends a data synchronization request message 110 to the server 100. The data synchronization request message contains a unique manufacturing number of the mobile terminal 200 or Subscriber Identity Module (SIM) card number attached to the mobile terminal 100 and TimeStamps for the data represented by icons (here, contact icon_{—}1 to icon_{—}5). If the data synchronization request message 110 is received, then the server 100 compares the currently received data and the previously designated data per icon and synchronizes 120 the data based on the comparison result. After data synchronization 120 has completed, the server 100 sends a data synchronization response message 130 (Sync Srv) to the mobile terminal 200 for acknowledging the data synchronization.

Typically, the change of the data represented by the icon is done with the SIM card attached to the mobile terminal 200. Accordingly, when the data represented by the icon is changed in another mobile terminal and then reattached to the mobile terminal 200, the data stored in the mobile terminal 200 by means of the SIM card and the server 100 do not match each other. The SIM card detached from the mobile terminal 200 can be attached to another mobile terminal and an icon displayed on the display screen of the new mobile terminal is changed in position. If the SIM card is reattached to the mobile terminal 200 later as the position of the icon has been changed, the mobile terminal 200 is not aware of the change of the position of the icon. Accordingly, when the icon is selected to make a call to the phone number represented by the icon, an error occur between the mobile terminal 200 and the server 100 due to the mismatch of the data related to the position of the icon.

### SUMMARY OF THE INVENTION

To address the above-discussed deficiencies of the prior art, it is a primary object to provide a server-based data management system and method for a mobile communication system that is capable of improving reliability of data synchronization between a server and a mobile terminal.

In accordance with an exemplary embodiment of the present invention, a server-based data management method for a mobile communication system including at least one mobile terminal that displays at least one shortcut icon and a server that stores per-icon position information of the at least one shortcut icon. The method includes transmitting a first per-icon position information of the at least one shortcut icon from the mobile terminal to the server; comparing, at the server, the first per-icon position information with a second per-icon position information that is previously stored in server; transmitting the second per-icon position information that is not identical with the first per-icon position information from the server to the mobile terminal; and updating, at the mobile terminal, the first per-icon position information to the second per-icon position information.

In accordance with another exemplary embodiment of the present invention, a server-based data management system for a mobile communication system includes a mobile terminal that displays at least one shortcut icon, transmits a first per-icon position information of the at least one shortcut icon, and updates the first per-icon position information to a second per-icon position information received from outside. The system includes a server that stores the second per-icon position information of the at least one shortcut icon, compares the first per-icon position information received from the mobile terminal with the second per-icon position information, and transmits to the mobile terminal the second per-icon position information that is not identical with the first per-icon position information.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a sequence diagram for operations in a conventional server-based data management system comprising a server and a mobile terminal;

FIG. 2 illustrates a block diagram for a configuration of a mobile terminal for the server-based data management system according to an exemplary embodiment of the present invention;

FIG. 3 illustrates a sequence diagram for operations of a server-based data management system according to an exemplary embodiment of the present invention;

FIG. 4 illustrates a sequence diagram for operations of a server-based data management system comprising a server and a mobile terminal according to an exemplary embodiment of the present invention; and

FIG. 5 illustrates a flowchart for a server-based data management method for a mobile communication system according to an exemplary embodiment of the present invention.

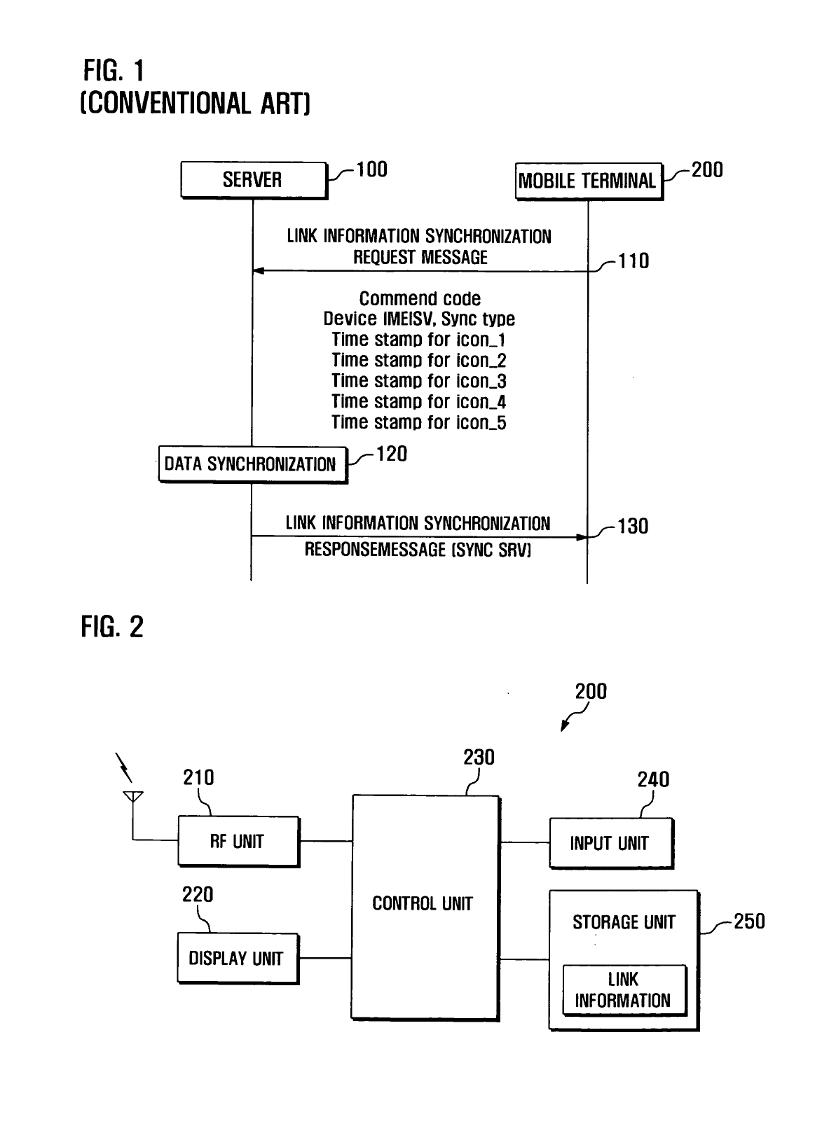

### DETAILED DESCRIPTION OF THE INVENTION

FIGS. 2 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications network. In the following description, the term “shortcut icon” is a link to a phone number appears in an idle mode screen of a mobile terminal. The shortcut icon can created in the form of a thumbnail image of the owner of the phone number or a character icon. The user can make a call to a specific phone number by clicking the shortcut icon linked to the phone number.

In the following description, the term “link information” denotes the user information mapped to a shortcut icon. The link information can include a phone number; name, email address, and residence address of the phone number's owner; and the information on the image used as the shortcut icon displayed in the idle mode screen. The link information also can include the types of the incoming and outgoing calls and emails, numbers of the respective calls and emails, times taken for the respective calls. The types of the calls include voice, video, and text message.

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

FIG. 2 illustrates a block diagram for a configuration of a mobile terminal for the server-based data management system according to an exemplary embodiment of the present invention.

Referring to FIG. 2, the mobile terminal 200 includes a Radio Frequency (RF) unit 210, a display unit 220, a control unit 230, an input unit 240, and a storage unit 250.

The RF unit 210 is responsible for transmitting and receiving radio signals carrying data for various communication services such as voice communication service, video communication service, Short Messaging Service (SMS), and Multimedia Messaging Service (MMS), and exchanging control data with a server 100. Particularly in an exemplary embodiment of the present invention, the RF unit 210 is responsible for processing the signals exchanged between the mobile terminal 200 and the server 100 in association with data synchronization.

The display unit 220 displays operation status and menu screens of the mobile terminal 200. The display unit 220 can be implemented with a Liquid Crystal Display (LCD). In case of using the LCD supporting touchscreen functionality, the display unit 220 can work as a part of the input unit 240. Particularly in an exemplary embodiment of the present invention, the display unit 220 displays the shortcut icons linked to the phone numbers to which the calls are frequently made under the control of the control unit 230.

The control unit 230 controls the operations of the internal function blocks of the mobile terminal 200. Particularly when a menu item or a key for requesting synchronization of the link data is clicked, the control unit 230 updates the modified link information using the link information stored in the server 100. Assuming a situation in that a SIM card, which is basically used with a first mobile terminal, is attached to a second mobile terminal such that a shortcut icon is changed in position according to a user manipulation or due to the designated number discount service (e.g., “My faves service”) environment of the second mobile terminal, the second mobile terminal sends the information on the changed position of the shortcut icon to the server 100. If the SIM card is reattached to the first mobile terminal later and the user requests a synchronization of the link information through a manipulation of menu or the input unit 240, the control unit 230 checks the link information and position information per shortcut icon and encodes the link information and position information per shortcut icon. Next, the control unit 230 sends the encoded link information and position information to the server 100 by means of the RF unit 210. Upon receipt of a link information acknowledgement message transmitted by the server 100, the control unit 230 of the first mobile terminal decodes the link information acknowledgement message. Next, the control unit 230 checks the position information per shortcut icon obtained by decoding the link information acknowledgement message and compares the position information received from the server 100 and the position information stored in the storage unit 250. Finally, the control unit 230 updates the old position information of the shortcut icons with the new position information received from the server 100 and stores the updated position information in the storage unit 250.

The input unit 240 receives the alphanumeric and function keys input by the user and outputs key sequences corresponding to the keys to the control unit 230. The input unit 240 can be implemented with a touchscreen or a normal keypad that is provided with a plurality of alphanumeric keys and function keys including soft keys. Particularly in an exemplary embodiment of the present invention, the input unit 240 is provided with a special function key to request for the link information synchronization between mobile terminal 200 and the server 100.

The storage unit 250 stores various application programs running in the mobile terminal 200 and the application data generated while the application programs are running. Particularly in an exemplary embodiment of the present invention, the storage unit 250 stores the link information. Here, the link information means the information mapped to the shortcut icon displayed on the screen of the display unit 220. The link information can include phone number; name, email address, and residence address of the phone number's owner; and the information on the image used as the shortcut icon. The link information also can include the position information of each shortcut icon on the screen of the display unit 220.

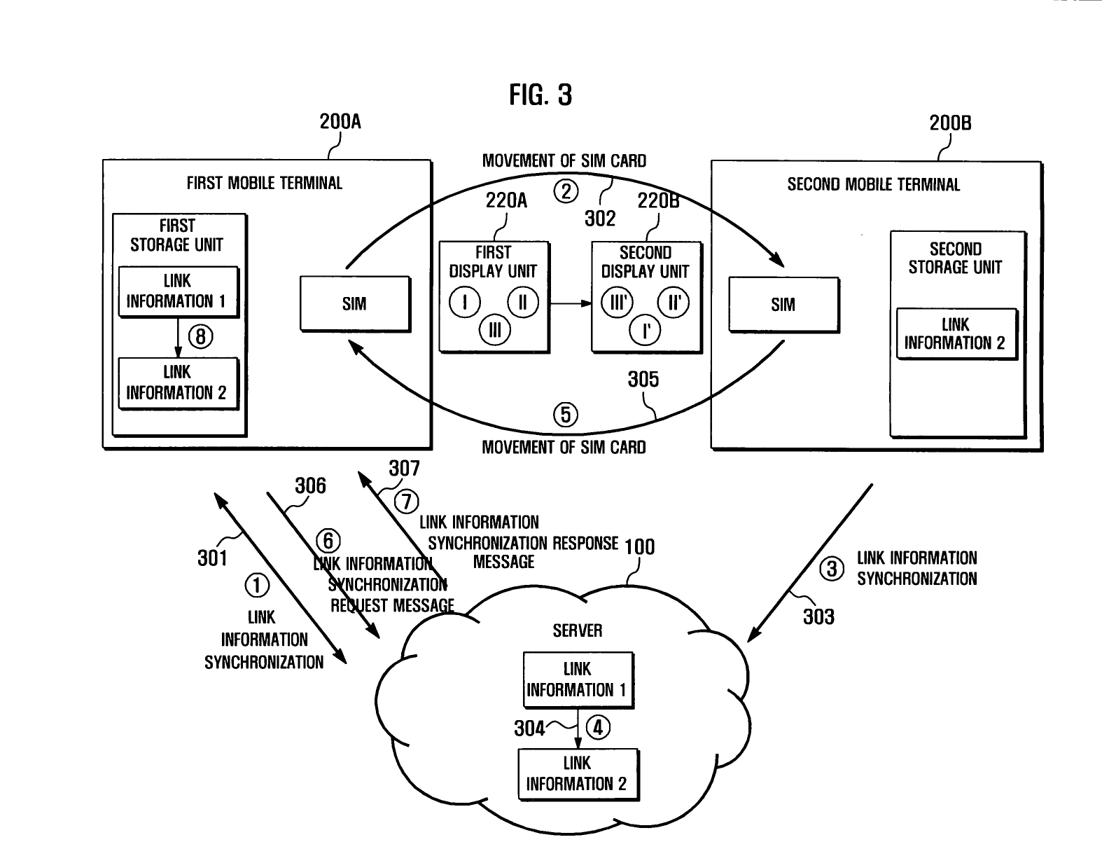

Until now, the internal function blocks constituting the mobile terminal has been described. A server-based data management system for synchronizing data between a mobile terminal and a server is described with reference to FIG. 3. FIG. 3 illustrates a sequence diagram for operations of a server-based data management system according to an exemplary embodiment of the present invention.

Referring to FIG. 3, in order to provide the designated number discount service (e.g., My faves service), link information is synchronized between the first mobile terminal 200A and the server 100 as link information 1 at step \textcircled{1} 301. It is assumed that three shortcut icons (shortcut icon I, shortcut icon II, and shortcut icon III) are displayed on a first display unit 220A of the first mobile terminal 200A. After the link information is synchronized between the first mobile terminal 200A and the server 100, the user detaches the SIM card from the first mobile terminal 200A and attaches the SIM card to a second mobile terminal 200B at step \textcircled{2} 302.

The second mobile terminal 200B activates the designated number discount service application according to the user command such that a designated number discount service application screen is displayed by means of the a second display unit 220B of the second mobile terminal 200B. At this time, the shortcut icons I, II, and III displayed in the designated number discount service application screen on the second display unit 220B of the second mobile terminal 200B are changed in positions in the designated number discount service application screen on the first display unit 220A of the first mobile terminal 200A according to the user's manipulation or the display configuration of the second mobile terminal 200B. The second mobile terminal 200B checks the positions of the shortcut icons in the designated number discount service application screen displayed on the second display unit 220B and creates and stores link information 2 including the position information. Next, the second mobile terminal 200B sends the link information 2 to the server 100 in order to synchronize the link information between the server 100 and the second mobile terminal 200B at step \textcircled{3} 303. Upon receipt of the link information 2, the server 100 updates the link information 1, which is the link information synchronized between the first mobile terminal 200A and the server 100, to the link information 2 received from the second mobile terminal 200B at step \textcircled{4} 304.

Next, the user detaches the SIM card from the second mobile terminal 200B and reattaches the SIM card to the first mobile terminal 200A at step \textcircled{5} 305. If a link information synchronization request command is input by a menu selection or a function key selection, the first mobile terminal 200A sends a link information synchronization request message containing the link information 1 to the server 100 at step \textcircled{6} 306. If the link information synchronization request message is received, then the server 100 compares the link information 2 stored in its database with the link information 1 contained in the link information synchronization request message. If the link information 2 and the link information 1 differ from each other, the server 100 sends a link information synchronization response message containing the link message 2 to the first mobile terminal 200A in response to the link information synchronization request message at step \textcircled{7} 307. Upon receipt of the link information synchronization response message transmitted by the server 100, the first mobile terminal 200A updates the link information 1 to the link information 2 contained in the link information synchronization response message and stores the update link information, i.e., link information 2 at step \textcircled{8} 308.

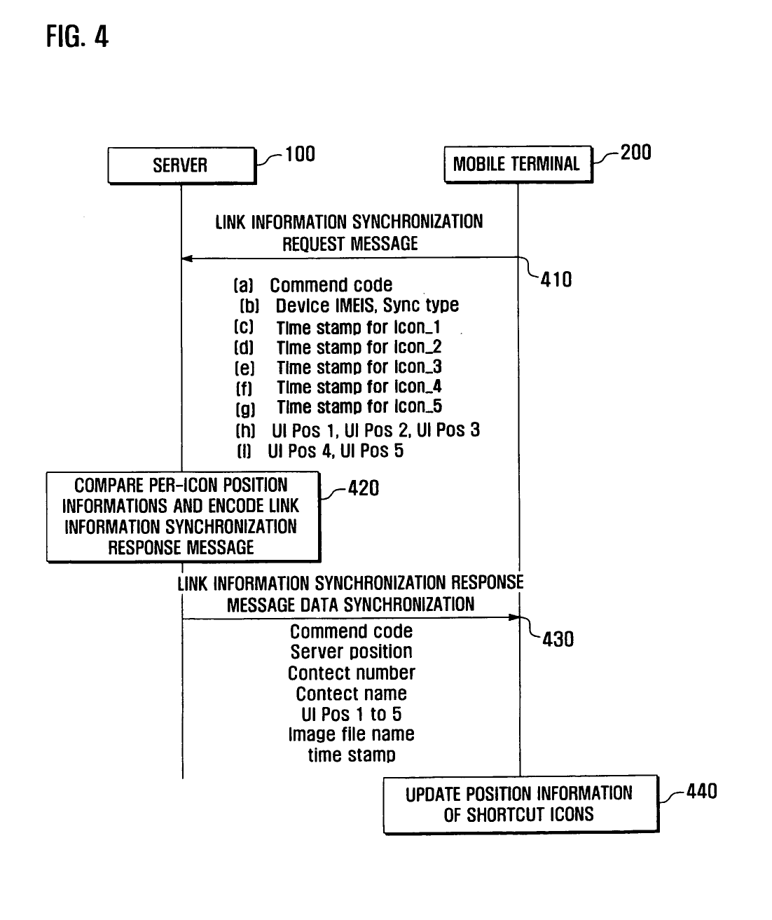

The signaling between the mobile terminals and the server 100 for data synchronization is described in more detail with reference to FIG. 4. FIG. 4 illustrates a sequence diagram for operations of a server-based data management system comprising a server and a mobile terminal according to an exemplary embodiment of the present invention.

Referring to FIG. 4, if a link information synchronization request command is input by a menu or a function key of the input unit 240, the control unit 230 of the mobile terminal 200 sends a link information synchronization request message 410 carrying the link information stored in the storage unit 250 by means of the RF unit 210. The link information includes a 2-digit command code (1), 16-digit manufacturing number of the mobile terminal 200 or a Device IMEISV information, which is a unique number of the SIM card, a 2-digit sync type information (b), 12-digit time stamps (c, d, e, f, and g) for indicating most recently updated times of link information per shortcut icon, and 2-digit position information (UI position), i.e., UIPos_1 to UIPos_5 (h, i), of the respective shortcut icons.

If the link information synchronization request message is received, the server 100 compares 420 the timestamp and position information per shortcut icon contained in the link information synchronization request message with those stored in its database. Next, the server 100 encodes the position information per shortcut icon into a link information synchronization response message based on the comparison result. For example, the server 100 compares the position information of each shortcut icon with the previously stored position information of the corresponding shortcut icon to check the shortcut icons that are changed in position. If there is at least one shortcut icon changed in position, the server 100 creates the link information synchronization response message 430 (Sync Srv) including the most recently updated position information of corresponding shortcut icon and sends the link information synchronization request message (Sync Srv) to the mobile terminal 200. Here, the link information synchronization response message (Sync Srv) includes the 2-digit command code, server position, 17-digit contact number, maximum 20-digit contact name, 2-digit per-shortcut icon position information, 25-digit image file name, and 2-digit timestamp.

Once the link information synchronization response message (Sync Srv) is received, the control unit 230 of the mobile terminal 200 checks the per-shortcut icon position information and compares the per-shortcut icon position information extracted from the link information synchronization response message (Sync Srv) with the corresponding position information of the shortcut icons stored in the storage unit 250. Finally, the mobile terminal 200 updates 440 the position information of the shortcut icons stored in the storage unit 250 with the corresponding position information extracted from the link information synchronization response message (Sync Srv).

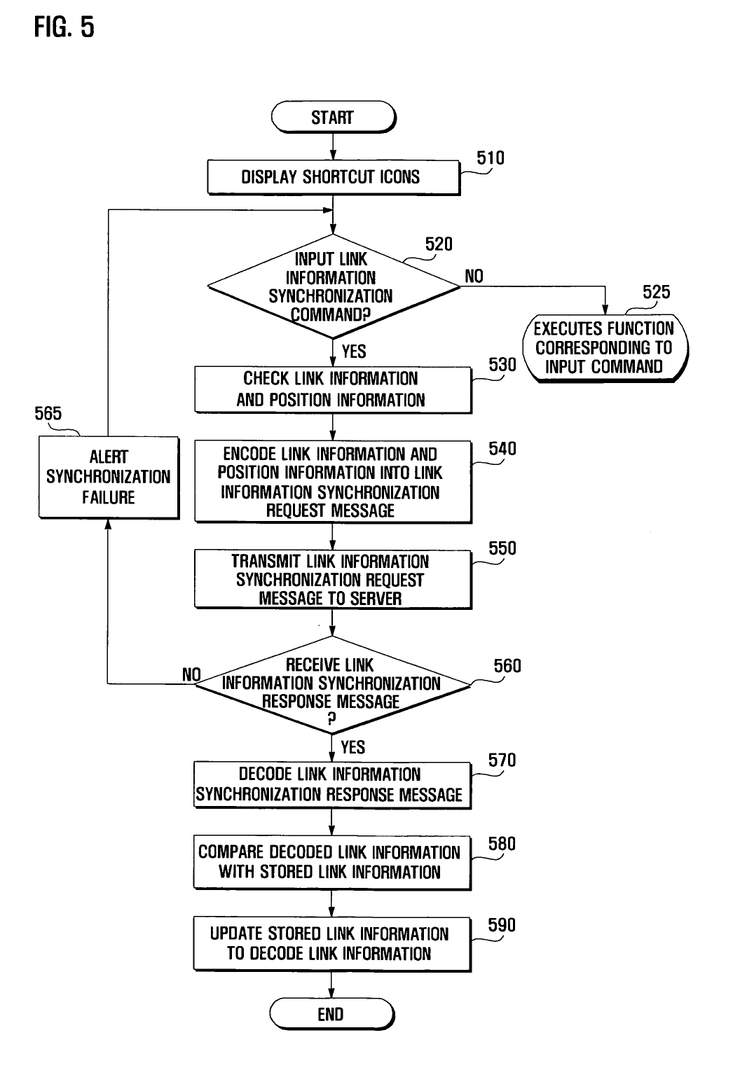

A server-based data management method for a mobile communication system is described in detail with reference to FIG. 5. FIG. 5 illustrates a flowchart for a server-based data management method for a mobile communication system according to an exemplary embodiment of the present invention.

Referring to FIG. 5, the control unit 230 first displays an application screen in which the shortcut icons are arranged at the preset positions according to the activation of the application in response to an application execution command (step 510). Next, the control unit 230 monitors to detect a user command input and, if any, determines whether the user command is a link information synchronization request command (step 520). If the detected user command is not the link information synchronization request command, the control unit 230 executes a function corresponding to the user command. The function can be a voice communication function, a video communication function, a text messaging function, an image sharing function, or the like. For example, when the user selects a shortcut icon displayed in application screen, the control unit 230 controls such that the owner's information of the phone number linked to the selected shortcut icon together with the available functions such as voice communication function, text messaging function, image transmission function, and the like. Thereafter, if the user selects the voice communication function, the control unit 230 controls the RF unit 210 to establish a channel with the terminal having the phone number linked to the shortcut icon for voice communication.

Otherwise, if the detected user command is the link information synchronization request command at step 520, the control unit 230 checks the link information and position information of each shortcut icon that are stored in the storage unit 250 (step 530). Next, the control unit 230 encodes the link information and position information of the shortcut icons into a link information synchronization request message (step 540) and sends the link information synchronization request message to the server 100 by means of the RF unit 210 (step 550).

Next, the control unit 230 determines whether a link information synchronization response message is received from the server 100 in response to the link information synchronization request message by means of the RF unit 210 (step 560). If no link information synchronization response message is received in a predetermined time, the control unit 230 controls such that an alert message notifying the link information synchronization failure is displayed on the display unit 220 (step 565), and process goes to step 520.

Otherwise, if a link information synchronization response message is received at step 560, the control unit 230 decodes the link information synchronization response message to extract the link information and position information per shortcut icon (step 570). Next, the control unit 230 compares the extracted link information and position information with those stored in the storage unit 250 per shortcut icon (step 580).

Finally, the control unit 230 updates the link information and position information of the shortcut icons stored in the storage unit 250 to the corresponding link information and position information extracted from the link information synchronization response message (step 590). For example, the control unit 230 checks the position information extracted from the link information synchronization response message and determines whether the extracted position information is identical with the corresponding position information stored in the storage unit 250 per shortcut icon. If the extracted position information is not identical with the corresponding position information stored in the storage unit 250, the control unit 230 replaces the position information stored in the storage unit 250 with the position information extracted from the link information synchronization response message.

Although not illustrated in the drawing, the serve-base data management method of FIG. 5 can further include steps for comparing the timestamp included in the link information stored in the storage unit 250 and the timestamp included in the link information extracted from the link information synchronization response message per shortcut icon and determines whether to update the position information with reference to the most recently update time. That is, the control unit 230 checks the update time of the position of each shortcut icon with reference to the timestamps extracted from the link information synchronization response message (Sync Srv) transmitted by the server 100 and compares the update time with that stored in the storage unit 250. As a consequence, the control unit 230 stores the per-shortcut icon position information updated most recently in the storage unit 250. Although the server-based data management method is described with an exemplary procedure for synchronizing position information of short icons between the mobile terminal 200 and the server 100, the present invention is not limited there. For example, other information included in the link information of the shortcut icons can be synchronized between the mobile terminal 200 and the server 100 in the above described manner.

As described above, the server-based data management system and method of the present invention allows a server to manage link information on the shortcut icons displayed in a specific application screen of the mobile terminal and updates the link information when the position of the shortcut icons especially in another mobile terminal, whereby the mobile terminal can maintain the link information including position information on the shortcut icons in synchronization with the server. In the server-base data management system and method of the present invention, the mobile terminal sends the information on the position information of all shortcut icons to the server and updates the position information with the corresponding position information received from the server, thereby maintaining synchronization of the most recently updated position information with the server.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A server-based data management method for a mobile communication system including at least one mobile terminal which displays at least one shortcut icon and a server which stores per-icon position information of the at least one shortcut icon, comprising:
transmitting a first per-icon position information of the at least one shortcut icon from the mobile terminal to the server;
receiving, by the mobile terminal, a second per-icon position information that is not identical with the first per-icon position information from the server; and
updating, at the mobile terminal, the first per-icon position information to the second per-icon position information.

2. The server-based data management method of claim 1, wherein transmitting a first per-icon position information comprises:
checking link information including the first per-icon position information of the at least one shortcut icon;
encoding the link information of the at least one shortcut icon; and
transmitting the encoded link information to the server.

3. The server-based data management method of claim 2, wherein transmitting the encoded link information to the server comprises:
detecting an input of a link information synchronization command; and
transmitting the encoded link information in response to the link information synchronization command.

4. The server-based management method of claim 2, wherein the link information comprises at least one of a phone number, a name of the owner of the phone number, and an email address of the owner of the phone number.

5. The server-based management method of claim 1, further comprising: comparing, at the server, the first per-icon position information with the second per-icon position information that is previously stored in server.

6. The server-based management method of claim 1, wherein receiving comprises receiving a link information synchronization response message from the server, the link information synchronization response message including at least one of link information and at least one icon position information.

7. The server-based management method of claim 6, further comprising decoding the link information synchronization response message.

8. A server-based data management system for a mobile communication system, comprising:
a mobile terminal which displays at least one shortcut icon, transmits a first per-icon position information of the at least one shortcut icon, and updates the first per-icon position information to a second per-icon position information' received from outside; and
a server which stores the second per-icon position information of the at least one shortcut icon, compares the first per-icon position information received from the mobile terminal with the second per-icon position information, and transmits to the mobile terminal the second per-icon position information that is not identical with the first per-icon position information.

9. The server-based data management system of claim 8, wherein the mobile terminal comprises:
a display unit which displays the at least one shortcut icon;
a storage unit which stores the first per-icon position information of the at least one shortcut icon;
a radio frequency unit which transmitting a radio signal carrying the first per-icon position information to the server; and
a control unit which controls display of the at least one shortcut icon by means of the display unit, transmission of the first per-icon information to the server by means of the radio frequency unit, and the update of the first per-icon position information to the second per-icon position information.

10. The server-based data management system of claim 9, wherein the control unit encodes link information including the first per-icon position information and transmits the encoded link information to the server by means of the radio frequency unit.

11. The server-based data management system of claim 10, wherein the control unit detects an input of a link information synchronization request command and transmitting the first per-icon position information to the server by means of the radio frequency unit.

12. The server-base data management system of claim 10, wherein the link information comprises at least one of a phone number, a name of the owner of the phone number, and an email address of the owner of the phone number.

13. The server-base data management system of claim 8, wherein the server transmits a link information synchronization response message, the link information synchronization response message including at least one of link information and at least one icon position information.

14. The server-base data management system of claim 13, wherein the mobile terminal is configured to decode the link information synchronization response message.

15. A mobile terminal capable of communicating in a wireless communication network, the mobile terminal comprising:
a display unit which displays the at least one shortcut icon;
a storage unit which stores the first per-icon position information of the at least one shortcut icon;
a radio frequency unit which transmitting a radio signal carrying the first per-icon position information to the server; and
a control unit configured to control a display of the at least one shortcut icon by means of the display unit, a transmission of the first per-icon information to the server by means of the radio frequency unit, and an update of the first per-icon position information to the second per-icon position information.

16. The mobile terminal of claim 15, wherein the mobile terminal is configured to communicate with a server in the wireless communication network, the server configured to store the second per-icon position information of the at least one shortcut icon, compare the first per-icon position information received from the mobile terminal with the second per-icon position information, and transmits to the mobile terminal the second per-icon position information that is not identical with the first per-icon position information.

17. The mobile terminal of claim 15, wherein the control unit encodes link information including the first per-icon position information and transmits the encoded link information to the server by means of the radio frequency unit.

18. The mobile terminal of claim 17, wherein the control unit detects an input of a link information synchronization request command and transmitting the first per-icon position information to the server by means of the radio frequency unit.

19. The mobile terminal of claim 17, wherein the link information comprises at least one of a phone number, a name of the owner of the phone number, and an email address of the owner of the phone number.

20. The mobile terminal of claim 15, wherein the server transmits a link information synchronization response message, the link information synchronization response message including at least one of link information and at least one icon position information and wherein the mobile terminal is configured to decode the link information synchronization response message.
